(19) United States
(12) Patent Application Publication
(10) Pub. No.: US 2026/0330098 A1
(43) Pub. Date: Oct. 22, 2026

(54) SYSTEM AND METHOD OF DETERMINING A MATERIAL UTILIZATION PERCENTAGE FOR NUMERICALLY STAMPED PARTS

(71) Applicant: GM GLOBAL TECHNOLOGY OPERATIONS LLC, Detroit, MI (US)

(72) Inventors: Ziqiang Sheng, Troy, MI (US); Kleber M. Cabral, Auburn Hills, MI (US); Adam R. Groseclose, Sterling Heights, MI (US); Michael J. Watson, Lapeer, MI (US)

(73) Assignee: GM GLOBAL TECHNOLOGY OPERATIONS LLC, Detroit, MI (US)

(21) Appl. No.: 19/180,911

(22) Filed: Apr. 16, 2025

(51) Int. Cl. G06F 30/23; G06F 30/17

(52) U.S. Cl. CPC G06F 30/23; G06F 30/17

(57) ABSTRACT

A system of determining a material utilization percentage during a stamping process includes a first input including at least one finite element model (FEM) data file, a second input including a margin between an edge of an initial blank and an edge of a developed blank geometry, a third input including a selected material type, a graphical user interface (GUI), a finite element method (FEM) model database for receiving the first input via the GUI, a materials database for receiving the third input via the GUI, and a controller configured to calculate a mass of the initial blank and a mass of a formed part based on the first input, second input, and third input, and calculate a material utilization percentage based on the mass of the initial blank and the mass of the formed part.

### INTRODUCTION

The concepts described herein relate generally to systems and methods of material utilization for stamped parts. More specifically, aspects of this disclosure relate to a mass-based system and method for determining material utilization during a computer numerically controlled (CNC) sheet metal stamping process based on a mass ratio of a formed part to a part blank.

A sheet metal stamping process generally includes using a stamping press to cut and form a flat sheet of metal into a desired shape utilizing various techniques, for example but not limited to, blanking, drawing, ironing, bending, piercing, and/or trimming.

Blanking includes cutting the flat sheet of metal into an approximate size of a finished part using a punch and die set. Drawing includes deep drawing, in which the blank is progressively formed into, for example but not limited to, a cylindrical shape, by pulling the blank over a die with a decreasing radius. Ironing is a process that can be used after deep drawing, which includes further pressing the deep drawn blank through a specialized ironing die to uniformly reduce its wall thickness while maintaining the overall shape. Bending includes using specialized bending dies to form flanges and/or lips, if required. Piercing includes using punches to create openings within the part, if required. Trimming includes removing excess material from edges of the part to achieve precise dimensions.

A CNC sheet metal stamping process automates the control, movement and precision of the machine tools used in each of the techniques above through the use of preprogrammed computer software.

Sheet metal utilization during a CNC stamping process is calculated using an area-based material utilization method that uses a ratio between an area of a final part and an area of the part blank. However, as a blank thickness can change during processes such as drawing and/or ironing, which are generally used to make, for example but not limited to, battery cans used in battery cells, accuracy of the area-based material utilization method is reduced, resulting in unreliable material cost and inventory management.

### SUMMARY

In view of the above discussion, it is useful to develop a system and method of determining a mass-based material utilization percentage for stamped parts based on a mass ratio of an initial blank to a formed part to provide a material utilization percentage having increased accuracy, resulting in increased material cost and inventory management reliability.

A stamping process may include feeding a coil of metal material, for example but not limited to, aluminum and/or steel, into a blanking die, which is movable vertically to cut an initial blank having a length, a width, and a first thickness from the coil of metal material.

The initial blank may then be fed into a deep drawing die having an upper die and a blank holder, which may be movable vertically along a first post to draw the initial blank into a cavity, reducing the first thickness of the initial blank to an in-process blank having a second thickness, which may include up to a 30% reduction in thickness from the first thickness.

The in-process blank may then be fed into ironing die, which may be movable vertically along a second post to reduce the second thickness of the in-process blank to a formed part having a third thickness, which may include up to a 50% reduction in thickness from the second thickness.

According to one aspect of the disclosure, an initial blank may have a length, a width, a first thickness, and an initial blank edge, which may be defined as a circumference of the initial blank. A developed blank geometry has an edge that may be defined as a circumference of the developed blank geometry. A margin may be defined between the edge of the initial blank and the edge of the developed blank geometry.

The in-process blank may include a second length, and a second thickness.

The formed part may include a second length, and a third thickness.

According to one aspect of the disclosure, a system of determining a material utilization percentage during a stamping process may include a first input, a second input, a third input, a graphical user interface (GUI), a finite element method (FEM) model database for receiving the first input via the GUI, a materials database for receiving the third input, a controller configured to determine an output, which may include the material utilization percentage, based on the first input, the second input, and the third input.

According to another aspect of the disclosure, a method of determining a material utilization percentage MU during a stamping process is also disclosed.

The method of determining the material utilization percentage may include: receiving, via a graphic user interface (GUI), a first user input, wherein the first user input may include at least one finite element model (FEM) data file, wherein the GUI may be configured to send the first user input into a FEM model database; reading, via the controller, at least one of a developed blank geometry and/or a formed part geometry each of which may be represented by a plurality of elements, wherein the developed blank geometry and/or the formed part geometry may be read from the at least one FEM data file received, and wherein the plurality of elements for each of the developed blank geometry and/or the formed part geometry may include a plurality of nodes that may be associated with each of the plurality of elements; determining, via the controller, a nominal blank thickness of the developed blank geometry may be based on the plurality of elements read from the FEM model database; receiving, via the GUI, a second user input, wherein the second user input may include a margin between an edge of an initial blank and an edge of the developed blank geometry, wherein the GUI may be configured to send the second user input to the controller; determining, via the controller, a length and a width of the initial blank, wherein each of the length and the width of the initial blank may be determined based upon the plurality of the nodes that may be associated with each of the plurality of elements representing the developed blank geometry, and the margin received; receiving, via the GUI, a third user input, wherein the third user input may include a selected material type, and wherein the GUI may be configured to send the third user input to the controller; comparing, via the controller, the selected material type with material data that may be stored within a materials database, wherein the material data may include a plurality of material types, and at least one material characteristic that may be associated with each of the plurality of material types; identifying, via the controller, the at least one material characteristic for the selected material type received; calculating, via the controller, a mass of the initial blank and a mass of a formed part, wherein the mass of the initial blank is calculated based upon the nominal thickness of the developed blank geometry determined, and the length and the width of the initial blank determined, and the mass of a formed part is calculated based upon the at least one material characteristic identified, and an accumulated mass of each of the plurality of elements representing the developed blank geometry and/or the formed part geometry; and calculating, via the controller, the material utilization percentage based upon the mass of the initial blank and the mass of the formed part calculated.

According to one aspect of the disclosure, the initial blank is defined as being coplanar with an X-Y plane, and determining the nominal blank thickness of the developed blank geometry based on the plurality of element may include: reading, via the controller, the plurality of elements representing the developed blank geometry from the FEM model database; and looping, via the controller, through the plurality of elements representing the developed blank geometry.

Looping through the plurality of elements representing the developed blank geometry may include: reading, via the controller, a part identification, and an element thickness for each of the plurality of elements representing the developed blank geometry from the FEM model database; determining, via the controller, a maximum thickness of the developed blank geometry based on the element thickness for each of the plurality of elements representing the developed blank geometry; determining, via the controller, a minimum thickness of the developed blank geometry based on the element thickness for each of the plurality of elements representing the developed blank geometry; calculating, via the controller, an absolute thickness difference of the developed blank geometry based on the maximum thickness of the developed blank geometry determined and the minimum thickness of the developed blank geometry determined; and determining, via the controller, the nominal blank thickness of the developed blank geometry based on an average of the maximum thickness of the developed blank geometry determined and the minimum thickness of the developed blank geometry determined, when the absolute thickness difference calculated may be greater than a predefined allowable thickness difference.

According to one aspect of the disclosure, the method may further include identifying, via the controller, the nominal blank thickness as uniform, when the absolute thickness difference determined is less than the predefined allowable thickness difference.

According to one aspect of the disclosure, determining the length and the width of the initial blank may include: reading, via the controller, the plurality of nodes that may be associated with each of the plurality of elements representing the developed blank geometry from the FEM model database; and looping, via the controller, through the plurality of nodes that may be associated with each of the plurality of elements representing the developed blank geometry.

Looping through the plurality of nodes that may be associated with each of the plurality of elements representing the developed blank geometry may include: reading, via the controller, an X-coordinate, a Y-coordinate, and a Z-coordinate for each of the plurality of nodes that may be associated with each of the plurality of elements representing the developed blank geometry; identifying, via the controller, a minimum X value, a maximum X value, a minimum Y value and a maximum Y value for the initial blank; determining, via the controller, the length of the initial blank based on the minimum X value identified and the maximum X value identified; and determining, via the controller, the width of the initial blank based on the minimum Y value identified and the maximum Y value identified.

The accumulated mass Mᵢ of each of the plurality of elements j of part (i) may be calculated using the following equation [EQ. 1]:

$${M}_{i} = ρ {\sum }_{j = 1}^{N ( i )} {t}_{i}^{j} {A}_{i}^{j} ; \qquad [ EQ . 1 ]$$

wherein:
   ρ=a density of the sheet material;
   N(i)=a number of elements in a part (i);
   j=a number of elements in part (i);
   i=a part identification, wherein i is equal to 1 or 2;

$${t}_{i}^{j} = a thickness of a {j}^{th} element of an {i}^{th} part identified ; and$$

$${A}_{i}^{j} = an area of the {j}^{th} element of the {i}^{th} part identified .$$

The mass of the initial blank (Mb) and the mass of the formed part (Mp) may be calculated using the following equations [EQ. 2] and [EQ.3]:

Mb=L*W*ρ*t [EQ. 2];
wherein:
   L=the length of the initial blank;
   W=the width of the initial blank;
   ρ=a density of the sheet material; and
   t=an initial blank thickness; and

if M₁>M₂, then Mρ=M₂; else Mρ=M₁ [EQ. 3].

According to one aspect of the disclosure, the material utilization percentage may be calculated using the following equation [EQ. 4]:

$$MU = \frac{Mp}{Mb} * 100. \qquad [ EQ . 4 ]$$

By providing a system and method of determining a mass-based material utilization percentage for stamped parts based on a ratio of a mass of an initial blank to a mass of a formed part, a material utilization percentage is calculated with increased accuracy, resulting in increased material cost and inventory management reliability.

It should be appreciated that by providing a material utilization percentage that is calculated with increased accuracy, the material utilization percentage can be used by other systems, including but not limited to material order systems, to increase material cost and inventory management reliability by reducing an amount of material ordered to more closely reflect an actual amount of material to be ordered, and an actual amount of material on-hand.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is a schematic illustration of a sheet metal stamping process in accordance with the present disclosure.

FIG. 1A is a schematic illustration of an initial blank in accordance with the present disclosure.

FIG. 1B is a schematic illustration of an in-process blank in accordance with the present disclosure.

FIG. 1C is a schematic illustration of a formed part in accordance with the present disclosure.

FIG. 2 is a schematic illustration of a system for determining a material utilization percentage in accordance with the present disclosure.

FIG. 3 is a schematic illustration of a flow chart illustrating a mass-based system and method for determining a material utilization percentage during a sheet metal stamping process based on a mass ratio of a formed part to a part blank in accordance with the present disclosure.

FIG. 4 is a schematic illustration of a flow chart illustrating a zero thickness difference based method for determining an initial blank thickness (i.e., blank thickness before forming) in accordance with the present disclosure.

FIG. 5 is a schematic illustration of a flow chart illustrating a method for determining a size of an initial blank in accordance with the present disclosure.

FIG. 6 is a schematic illustration of a flow chart illustrating a method for determining part mass and blank mass in accordance with the present disclosure.

The appended drawings are not necessarily to scale, and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “of” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

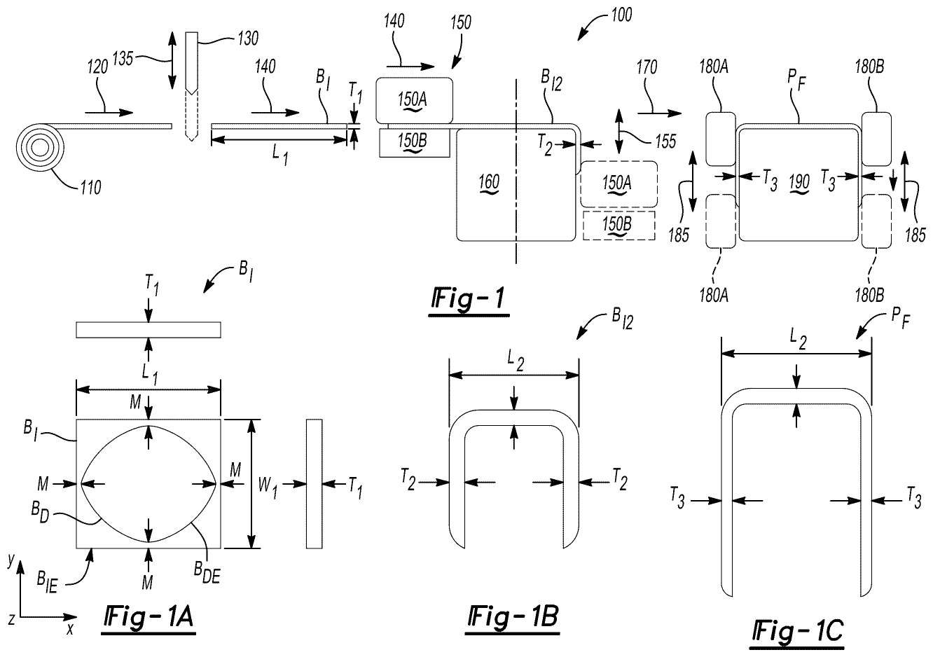

As schematically illustrated in FIG. 1, a stamping process 100 includes feeding 110 a coil 120 of metal material, for example but not limited to, aluminum and/or steel, into a blanking die 130, which is movable vertically 135 to cut an initial blank B₁ (FIG. 1A) having a length L₁, a width W₁, and a first thickness T₁ from the coil 120 of metal material.

The initial blank B₁ is then fed 140 into a deep drawing die 150 having an upper die 150A and a blank holder 150B, which is movable vertically 155 along a first post 160 to reduce the first thickness T₁ of the initial blank B₁ to an in-process blank B₁₂ having a second thickness T₂ (FIG. 1B), which may include up to a 30% reduction in thickness from the first thickness T₁.

The in-process blank B₁₂ is then fed 170 into ironing dies 180A, 180B, which are movable vertically 185 along a second post 190 to reduce the second thickness T₂ of the in-process blank B₁₂ to a formed part P_{F} having a third thickness T₃ (FIG. 1C), which may include up to a 50% reduction in thickness from the second thickness T₂.

As schematically illustrated in FIG. 1A, an initial blank B₁ includes a length L₁, a width W₁, a first thickness T₁, and an initial blank edge B_{IE}, which is defined as a circumference of the initial blank B₁. A developed blank B_{D} geometry has an edge B_{DE} that is defined as a circumference of the developed blank B_{D} geometry. A margin M is defined between the edge B_{IE} of the initial blank B₁ and the edge B_{DE} of the developed blank B_{D} geometry.

As schematically illustrated in FIG. 1B, an in-process blank B₁₂ geometry includes a second length L₂, and a second thickness T₂.

As schematically illustrated in FIG. 1C, a formed part P_{F} includes a second length L₂, and a third thickness T₃.

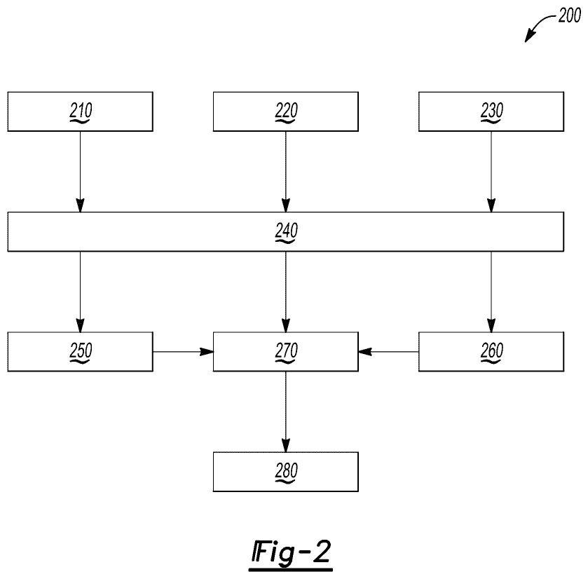

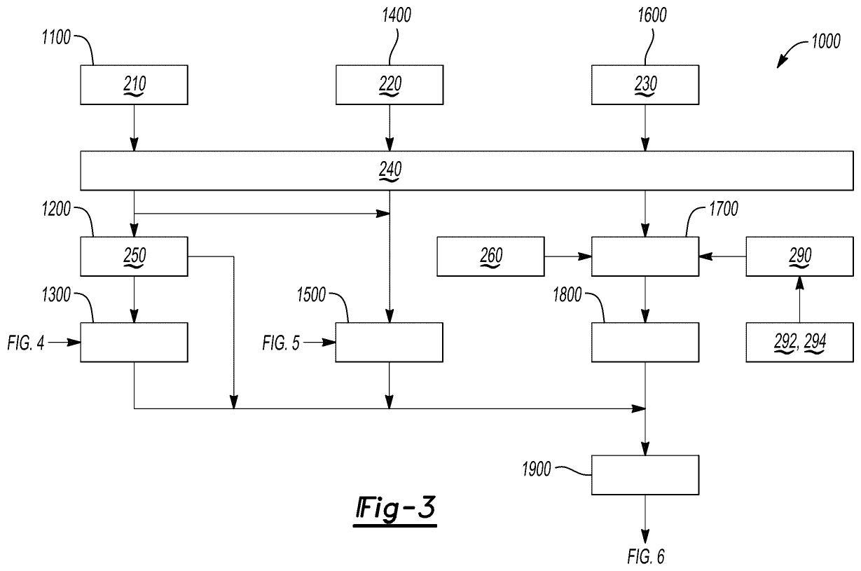

A system 200 that utilizes a method 1000 (FIG. 3) for determining a material utilization percentage MU during a stamping process 100 is schematically illustrated as a flow chart in FIG. 2.

The system 200 includes a first input 210, a second input 220, a third input 230, a graphical user interface (GUI) 240 for receiving the first user input 210, the second user input 220, and the third user input 230, a finite element method (FEM) model database 250 for receiving the first input 210 from the GUI 240, a materials database 260 for receiving the third input 230, a controller 270 configured to determine an output 280, which includes the material utilization percentage MU, based on the first input 210, the second input, 220, and the third input 230.

A method 1000 of determining a material utilization percentage MU during a stamping process 100 is schematically illustrated in FIG. 3.

The method 1000 of determining the material utilization percentage MU includes: receiving 1100, via a graphic user interface 240, a first user input 210, wherein the first user input 210 includes at least one finite element model (FEM) data file, and wherein the GUI 240 is configured to send the first user input 210 to a finite element method (FEM) model database 250; reading 1200, via the controller 270, a developed blank B_{D} geometry and/or a formed part P_{F} geometry, wherein each of the developed blank B_{D} geometry and/or the formed part P_{F} geometry is represented by a plurality N of elements j, wherein at least one of the developed blank B_{D} geometry and/or the formed part P_{F} geometry is read from the at least one FEM data file 210 received at 1100, and wherein each of the plurality of elements j includes a plurality M of nodes/associated with each of the plurality N of elements j; determining 1300, via the controller 270, a nominal blank thickness NT of the developed blank B_{D} geometry based on the plurality N of elements j representing the developed blank B_{D} geometry read from the FEM model database 250; receiving 1400, via the GUI 240, a second user input 220, wherein the second user input 220 includes a margin M between an edge B_{IE} of an initial blank B₁ and an edge B_{DE} of the developed blank B_{D} geometry, wherein the GUI 240 is configured to send the second user input 220 to the controller 270; determining 1500, via the controller 270, a length L₁ and a width W₁ of the initial blank B₁, wherein each of the length L₁ and the width W₁ of the initial blank B₁ are determined based upon the plurality of the nodes/associated with each of the plurality of elements representing the developed blank D_{B} geometry, and the margin received at 1400; receiving 1600, via the GUI 240, a third user input 230, wherein the third user input 230 includes a selected material type, and wherein the GUI is configured to send the third user input 230 to the controller 270; comparing 1700, via the controller 270, the selected material type 230 with material data 290 stored within a materials database 260, wherein the material data 290 includes a plurality of material types 292, and at least one material characteristic 294 associated with each of the plurality of material types 292; identifying 1800, via the controller 270, the at least one material characteristic 294 for the selected material type 230 received at 1600; calculating 1900, via the controller 270, a mass of the initial blank Mb and a mass of a formed part Mp, wherein the mass of the initial blank Mb is calculated based upon the nominal blank thickness NT of the developed blank B_{D} geometry determined at 1300, and the length L₁ and the width W₁ of the initial blank B₁ determined at 1500, and the mass of the formed part Mp is calculated based upon the material characteristic 294 identified at 1800, and an accumulated mass Mᵢ of each of the plurality of elements j representing the formed part P_{F} geometry calculated at 1900; and calculating 5000, via the controller 270, the material utilization percentage MU based upon the mass of the initial blank Mb and the mass of the formed part Mp calculated at 4200.

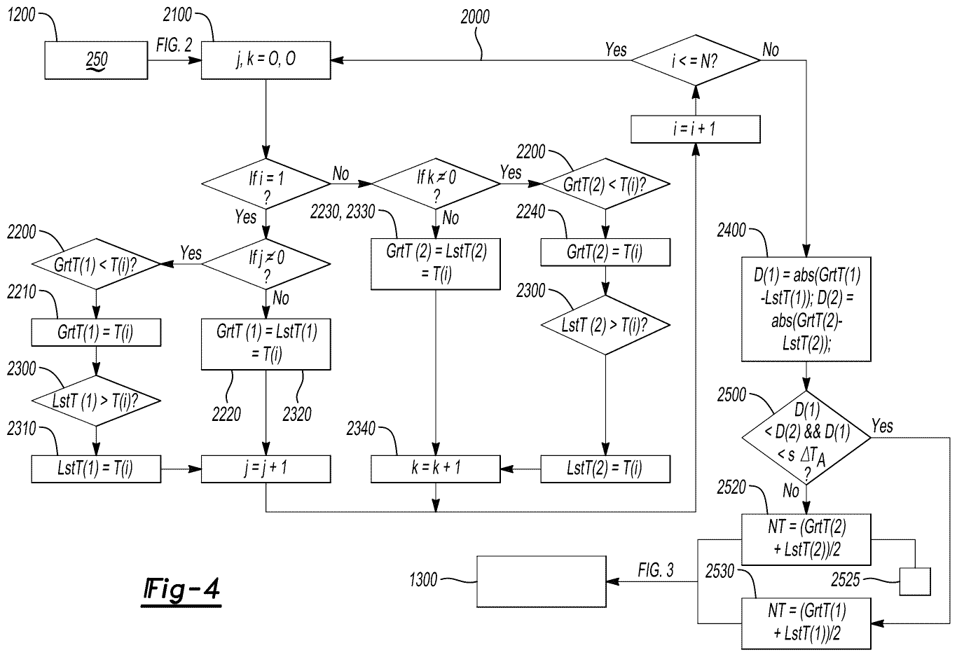

As schematically illustrated in FIG. 4, determining 1300 the nominal blank thickness NT of the developed blank B_{D} geometry based on the plurality N of elements j representing the developed blank B_{D} geometry includes: reading 1200, via the controller 270, the plurality N of elements j representing the developed blank B_{D} geometry from the FEM model database 250; and looping 2000, via the controller 270, through the plurality N of elements j representing the developed blank D_{B} geometry.

Looping 2000 through the plurality N of elements j representing the developed blank B_{D} geometry includes: reading 2100, via the controller 270, a part identification i, and an element thickness T(i) for each of the plurality N of elements j representing the developed blank B_{D} geometry from the FEM model database 250; determining 2200, via the controller 270, a maximum thickness GrtT 2210, 2220, 2230, 2240 of the developed blank B_{D} geometry based on the element thickness T(i) for each of the plurality N of elements j representing the developed blank B_{D} geometry; determining 2300, via the controller 270, a minimum thickness LstT 2310, 2320, 2330, 2340 of the developed blank B_{D} geometry based on the element thickness T(i) for each of the plurality N of elements j representing the developed blank B_{D} geometry; calculating 2400, via the controller 270, an absolute thickness difference D(i) of the developed blank B_{D} geometry based on the maximum thickness GrtT 2210, 2220, 2230, 2240 of the developed blank B_{D} geometry determined at 2200 and the minimum thickness LstT 2310, 2320, 2330, 2340 of the developed blank B_{D} geometry determined at 2300; and determining 2500, via the controller 270, the nominal blank thickness NT 2520, 2530 of the developed blank B_{D} geometry based on an average of the maximum thickness GrtT 2210, 2220, 2230, 2240 of the developed blank B_{D} geometry determined at 2200 and the minimum thickness LstT 2310, 2320, 2330, 2340 of the developed blank B_{D} geometry determined at 2300, when the absolute thickness difference D(i) calculated is greater than a predefined allowable thickness difference ΔT_{A}.

According to one aspect of the disclosure, the method 1000 of determining the material utilization percentage MU further includes identifying 2525, via the controller 270, the nominal blank thickness NT as uniform, when the absolute thickness difference determined 2500 is less than the predefined allowable thickness difference ΔT_{A}.

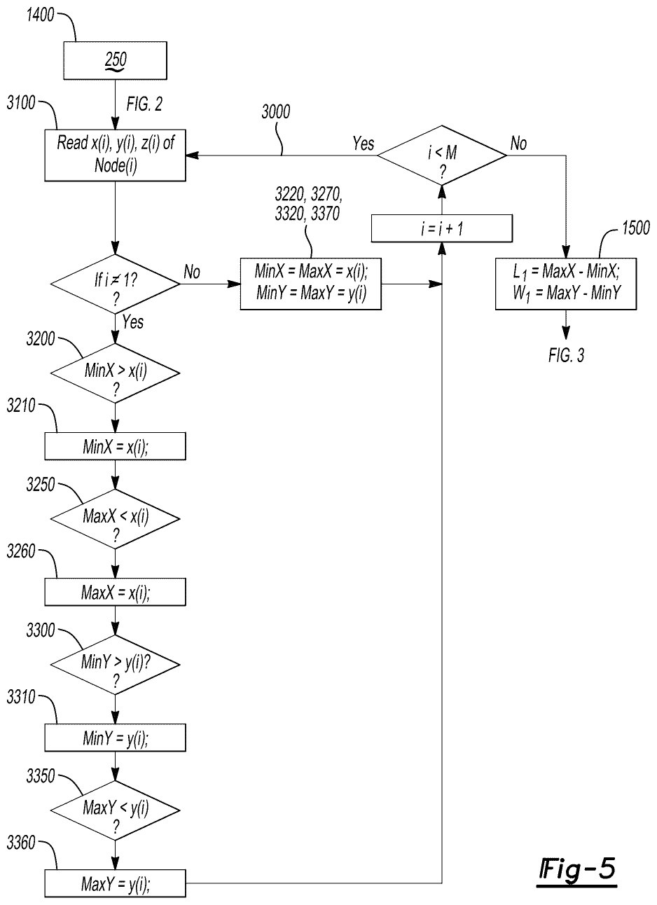

As schematically illustrated in FIG. 5, determining 1500 the length L₁ and the width W₁ of the initial blank B₁ includes: reading 3100, via the controller 270, the plurality M of nodes/associated with each of the plurality N of elements j representing the developed blank B_{D} geometry from the FEM model database 250; and looping 3000, via the controller 270, through the plurality M of nodes/associated with each of the plurality N of elements j representing the developed blank B_{D} geometry.

Looping 3000 through the plurality M of nodes/associated with each of the plurality N of elements j representing the developed blank B_{D} geometry includes: reading 3100, via the controller 270, an X-coordinate x(i), a Y-coordinate y(i), and a Z-coordinate z(i) for each of the plurality M of nodes/associated with each of the plurality N of elements j representing the developed blank B_{D} geometry; identifying 3200, 3300, via the controller 270, a minimum X value MinX 3210, 3220, a maximum X value MaxX 3260, 3270, a minimum Y value MinY 3310, 3320 and a maximum Y value MaxY 3360, 3370 for the initial blank B₁; determining 1500, via the controller 270, the length L₁ of the initial blank B₁ based on the minimum X value MinX 3210, 3220 identified at 3250 and the maximum X value MaxX 3260, 3270 identified at 3200; and determining 1500, via the controller 270, the width W₁ of the initial blank B₁ based on the minimum Y value MinY 3310, 3320 identified at 3300 and the maximum Y value MaxY 3360, 3370 identified at 3350.

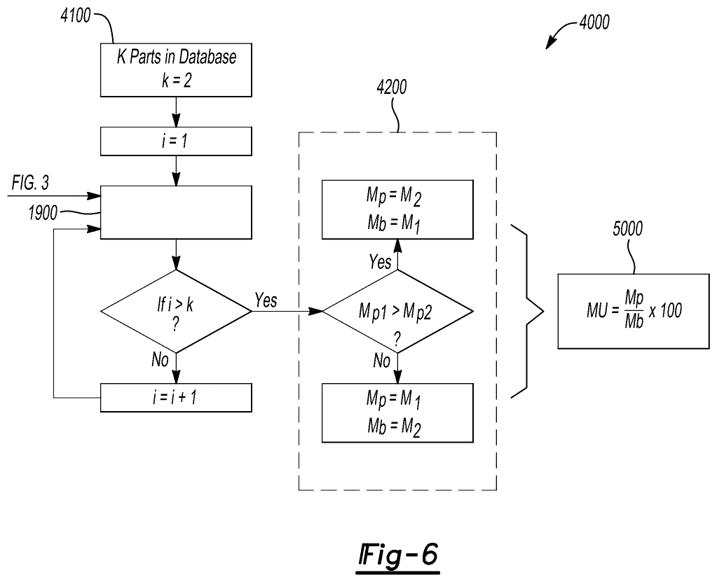

As schematically illustrated in FIG. 6, a method 4000 of calculating an accumulated mass Mᵢ of each of the plurality of elements j of part (i) for k parts 4100 in the FEM model database 250 is calculated at 1900 using the following equation [EQ. 1]:

$${M}_{i} = ρ {\sum }_{j = 1}^{N ( i )} {t}_{i}^{j} {A}_{i}^{j} ; \qquad [ EQ . 1 ]$$

wherein:
   ρ=a density of the sheet material;
   N(i)=a number of elements in a part (i);
   j=a number of elements in part (i);
   i=a part identification, wherein i is equal to 1 or 2;

$${t}_{i}^{j} = a thickness of a {j}^{th} element of an {i}^{th} part identified ; and$$

$${A}_{i}^{j} = an area of the {j}^{th} element of the {i}^{th} part identified .$$

According to one aspect of the disclosure, the mass of the formed part (Mp) and the mass of the initial blank (Mb) is calculated 4200 using the following equations [EQ. 2] and [EQ. 3]:

Mb=L*W*ρ*t [EQ. 2];
wherein:
   L=the length of the initial blank;
   W=the width of the initial blank;
   ρ=a density of the sheet material; and
   t=an initial blank thickness; and

if M₁>M₂,then Mρ=M₂; else Mρ=M₁ [EQ. 3].

According to one aspect of the disclosure, the material utilization percentage (MU) is calculated at 5000 using the following equation [EQ. 4]:

$$MU = \frac{Mp}{Mb} * 100. \qquad [ EQ . 4 ]$$

According to another aspect of the disclosure, a system 200 for determining a material utilization percentage MU during a stamping process 100 is also disclosed.

The system 200 for determining a material utilization percentage MU during a stamping process 100 includes a first user input 210, a second user input 220, a third user input 230, a finite element method (FEM) model database 250, a materials database 260, a graphic user interface 240 operable to receive the first user input 210, the second user input 220, and the third user input 230, and a controller 270 in communication with the FEM model database 250 and the materials database 260.

The GUI is configured to send the first user input 210 to the FEM model database 250, the second user input 220 to the controller 270, and the third user input 230 to the controller 270.

The second user input 220 is different from the first user input 210, and the third user input 230 is different from the first user input 210 and the second input 220.

The controller 270 is configured to receive 1100 the first user input 210, wherein the first user input 210 is received into the FEM model database 250 via the GUI 240, wherein the GUI 240 is configured to send the first user input 210 to the FEM model database; read 1200 a developed blank B_{D} geometry and/or a formed part P_{F} geometry, each represented by a plurality N of elements j, wherein the developed blank B_{D} geometry and/or the formed part P_{F} geometry is read from the first user input 210 received at 1100, and wherein each of the plurality N of elements includes a plurality M of nodes/associated with each of the plurality N of elements j representing each of the developed blank B_{D} geometry and/or the formed part P_{F} geometry; determine 1300 a nominal blank thickness NT of the developed blank B_{D} geometry based on the plurality N of elements/representing the developed blank B_{D} geometry read from the FEM model database 250; receive 1400 the second user input 220 via the GUI 240; determine 1500 a length L₁ and a width W₁ of the initial blank B₁, wherein each of the length L₁ and the width W₁ of the initial blank B₁ are determined based upon the plurality M of the nodes l associated with each of the plurality N of elements j represented by the developed blank B_{D} geometry, and the second user input 220 received at 1400; receive 1600 the third user input 230, wherein the third user input 230 is received into the materials database 260 via the GUI 240; compare 1700 the third user input 230 with material data 290 stored within the materials database 260, wherein the material data 290 includes a plurality of material types 292, and at least one material characteristic 294 associated with each of the plurality of material types 292; identify 1800 the at least one material characteristic 294 from the third user input 230 received; calculate 1900 a mass of the initial blank Mb and a mass of a formed part Mb, wherein the mass of the initial blank Mb is calculated based upon the nominal blank thickness NT of the developed blank B_{D} geometry determined at 1300, and the length L₁ and the width W₁ of the initial blank B₁ determined at 1500, and wherein the mass of the formed part Mb is calculated based upon the at least one characteristic identified at 1800, and an accumulated mass Mᵢ of each of the plurality of elements j representing the developed blank B_{D} geometry and/or the formed part P_{F} geometry; and calculate 5000 the material utilization percentage MU based upon the mass of the initial blank Mb and the mass of the formed part Mp.

As discussed above with respect to FIG. 4, determining 1300 the nominal blank thickness NT of the developed blank B_{D} geometry based on the plurality N of elements j representing the developed blank B_{D} geometry includes: reading 1200, via the controller 270, the plurality N of elements j for the developed blank B_{D} geometry from the FEM model database 250; and looping 2000, via the controller 270, through the plurality N of elements j representing the developed blank B_{D} geometry calculated at 1900.

Looping 2000 through the plurality N of elements j representing the developed blank B_{D} geometry includes: reading 2100, via the controller 270, a part identification i, and an element thickness T(i) for each of the plurality N of elements j representing the developed blank B_{D} geometry from the FEM model database 250; determining 2200, via the controller 270, a maximum thickness GrtT 2210, 2220, 2230, 2240 of the developed blank B_{D} geometry based on the element thickness T(i) for each of the plurality N of elements j representing the developed blank B_{D} geometry; determining 2300, via the controller 270, a minimum thickness LstT 2310, 2320, 2330, 2340 of the developed blank B_{D} geometry based on the element thickness T(i) for each of the plurality N of elements j representing the developed blank B_{D} geometry; calculating 2400, via the controller 270, an absolute thickness difference D(i) of the developed blank B_{D} geometry based on the maximum thickness GrtT 2210, 2220, 2230, 2240 of the developed blank B_{D} geometry determined at 2200 and the minimum thickness LstT 2310, 2320, 2330, 2340 of the developed blank B_{D} geometry determined at 2300; and determining 2500, via the controller 270, the nominal blank thickness NT 2510, 2520 of the developed blank B_{D} geometry based on an average 2520, 2530 of the maximum thickness GrtT 2210, 2220, 2230, 2240 of the developed blank B_{D} geometry determined at 2200 and the minimum thickness LstT 2310, 2320, 2330, 2340 of the developed blank B_{D} geometry determined at 2300, when the absolute thickness difference D(i) calculated is greater than a predefined allowable thickness difference ΔT_{A}.

According to one aspect of the disclosure, the method 1000 of determining the material utilization percentage MU further includes identifying 2525, via the controller 270, the nominal blank thickness NT as uniform, when the absolute thickness difference determined 2500 is less than the predefined allowable thickness difference ΔT_{A}.

As discussed above with respect to FIG. 5, determining 1500 the length L₁ and the width W₁ of the initial blank B₁ includes: reading 3100, via the controller 270, the plurality M of nodes/associated with each of the plurality N of elements j representing the developed blank B_{D} geometry from the FEM model database 250; and looping 3000, via the controller 270, through the plurality M of nodes/associated with each of the plurality N of elements j representing the developed blank B_{D} geometry.

Looping 3000 through the plurality M of nodes/associated with each of the plurality N of elements j representing the developed blank B_{D} geometry includes: reading 3100, via the controller 270, an X-coordinate x(i), a Y-coordinate y(i), and a Z-coordinate z(i) for each of the plurality M of nodes/associated with each of the plurality N of elements j representing the developed blank B_{D} geometry; identifying 3200, 3300, via the controller 270, a minimum X value MinX 3210, 3220, a maximum X value MaxX 3260, 3270, a minimum Y value MinY 3310, 3320 and a maximum Y value MaxY 3360, 3370 for the initial blank B₁; determining 1500, via the controller 270, the length L₁ of the initial blank B₁ based on the minimum X value 3210, 3220 identified at 3250 and the maximum X value 3260, 3270 identified at 3200; and determining 1500, via the controller 270, the width W₁ of the initial blank B₁ based on the minimum Y value MinY 3310, 3320 identified at 3300 and the maximum Y value MaxY 3360, 3370 identified at 3350.

As discussed above with respect to FIG. 6, the method 4000 of calculating an accumulated mass Mᵢ of each of the plurality of elements j of part (i) for k parts 4100 in the FEM model database 250 is calculated at 1900 using the following equation [EQ. 1]:

$${M}_{i} = ρ {\sum }_{j = 1}^{N ( i )} {t}_{i}^{j} {A}_{i}^{j} ; \qquad [ EQ . 1 ]$$

wherein:
   ρ=a density of the sheet material;
   N(i)=a number of elements in a part (i);
   j=a number of elements per part (i);
   i=a part identification, wherein i is equal to 1 or 2;

$${t}_{i}^{j} = a thickness of a {j}^{th} element of an {i}^{th} part identified ; and$$

$${A}_{i}^{j} = an area of the {j}^{th} element of the {i}^{th} part identified .$$

The method of determining the material utilization percentage as recited in claim 5, wherein the mass of the initial blank (Mb) and the mass of the formed part (Mp) is calculated at 4200 using the following equations [EQ. 2] and [EQ. 3] respectively:

Mb=L*W*ρ*t [EQ. 2];
wherein:
   L=the length of the initial blank;
   W=the width of the initial blank;
   ρ=a density of the sheet material; and
   t=an initial blank thickness; and

if M₁>M₂,then Mρ=M₂; else Mρ=M₁ [EQ. 3].

According to one aspect of the disclosure, the material utilization percentage (MU) is calculated 5000 using the following equation [EQ. 4]:

$$MU = \frac{Mp}{Mb} * 100. \qquad [ EQ . 4 ]$$

By providing a system and method of determining a mass-based material utilization percentage for stamped parts based on a ratio of a mass of an initial blank to a mass of a formed part, a material utilization percentage is calculated with increased accuracy, resulting in increased material cost and inventory management reliability.

It should be appreciated that by providing a material utilization percentage that is calculated with increased accuracy, the material utilization percentage can be used by other systems, including but not limited to material order systems, to increase material cost and inventory management reliability by reducing an amount of material ordered to more closely reflect an actual amount of material to be ordered, and an actual amount of material on-hand.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method of determining a material utilization percentage during a stamping process, the method comprising:
receiving, via a graphic user interface (GUI), a first user input, wherein the first user input includes at least one finite element model (FEM) data file, wherein the GUI is configured to send the first user input to a finite element method (FEM) model database;
reading, via a controller, a developed blank geometry and/or a formed part geometry, each of which are represented by a plurality of elements from the FEM model database, wherein the developed blank geometry and/or the formed part geometry is read from the at least one FEM data file received, and wherein each of the plurality of elements representing each of the developed blank geometry and/or the formed part geometry includes a plurality of nodes associated with each of the plurality of elements;
determining, via the controller, a nominal blank thickness of the developed blank geometry based on the plurality of elements representing the developed blank geometry read from the FEM model database;
receiving, via the GUI, a second user input, wherein the second user input includes a margin between an edge of an initial blank and an edge of the developed blank geometry, wherein the GUI is configured to send the second user input to the controller;
determining, via the controller, a length and a width of the initial blank, wherein each of the length and the width of the initial blank are determined based upon the plurality of the nodes associated with each of the plurality of elements representing the developed blank geometry, and the margin received;
receiving, via the GUI, a third user input, wherein the third user input includes a selected material type, and wherein the GUI is configured to send the third user input to the controller;
comparing, via the controller, the selected material type with material data stored within a materials database, wherein the material data includes a plurality of material types, and at least one material characteristic associated with each of the plurality of material types;
identifying, via the controller, the at least one material characteristic for the selected material type received;
calculating, via the controller, a mass of the initial blank and a mass of a formed part, wherein the mass of the initial blank is calculated based upon the nominal blank thickness of the developed blank geometry determined, and the length and the width of the initial blank determined, and wherein the mass of the formed part is calculated based upon the at least one characteristic identified, and an accumulated mass of each of the plurality of elements representing the formed part geometry; and
calculating, via the controller, the material utilization percentage based upon the mass of the initial blank and the mass of the formed part calculated.

2. The method of determining the material utilization percentage as recited in claim 1, wherein determining the nominal blank thickness of the developed blank geometry based on the plurality of elements representing the developed blank geometry includes:
reading, via the controller, the plurality of elements representing the developed blank geometry from the FEM model database; and
looping, via the controller, through the plurality of elements representing the developed blank geometry, wherein looping through the plurality of elements representing the developed blank geometry includes:
reading, via the controller, a part identification, and an element thickness for each of the plurality of elements representing the developed blank geometry from the FEM model database;
determining, via the controller, a maximum thickness of the developed blank geometry based on the element thickness for each of the plurality of elements representing the developed blank geometry;
determining, via the controller, a minimum thickness of the developed blank geometry based on the element thickness for each of the plurality of elements representing the developed blank geometry;
calculating, via the controller, an absolute thickness difference of the developed blank geometry based on the maximum thickness of the developed blank geometry determined and the minimum thickness of the developed blank geometry determined; and
determining, via the controller, the nominal blank thickness of the developed blank geometry based on an average of the maximum thickness of the developed blank geometry determined and the minimum thickness of the developed blank geometry determined, when the absolute thickness difference calculated is greater than a predefined allowable thickness difference.

3. The method of determining the material utilization percentage as recited in claim 2, further including:
identifying, via the controller, the nominal blank thickness as uniform, when the absolute thickness difference determined is less than the predefined allowable thickness difference.

4. The method of determining the material utilization percentage as recited in claim 2, wherein determining the length and the width of the initial blank includes:
reading, via the controller, the plurality of nodes associated with each of the plurality of elements representing the developed blank geometry from the FEM model database; and
looping, via the controller, through the plurality of nodes associated with each of the plurality of elements representing the developed blank geometry, wherein looping through the plurality of nodes associated with each of the plurality of elements representing the developed blank geometry includes:
reading, via the controller, an X-coordinate, a Y-coordinate, and a Z-coordinate for each of the plurality of nodes associated with each of the plurality of elements representing the developed blank geometry;
identifying, via the controller, a minimum X value, a maximum X value, a minimum Y value, and a maximum Y value for the initial blank;
determining, via the controller, the length of the initial blank based on the minimum X value identified and the maximum X value identified; and
determining, via the controller, the width of the initial blank based on the minimum Y value identified and the maximum Y value identified.

5. The method of determining the material utilization percentage as recited in claim 4, wherein the accumulated mass (Me) of each of the plurality of elements is calculated using the following equation [EQ. 1]:
$${M}_{i} = ρ {\sum }_{j = 1}^{N ( i )} {t}_{i}^{j} {A}_{i}^{j} ; \qquad [ EQ . 1 ]$$
wherein:
ρ=a density of the sheet material;
N(i)=a number of elements in a part (i);
j=a number of elements per part (i);
i=a part identification, wherein i is equal to 1 or 2;
$${t}_{i}^{j} = a thickness of a {j}^{th} element of an {i}^{th} part identified ; and$$
$${A}_{i}^{j} = an area of the {j}^{th} element of the {i}^{th} part identified .$$

6. The method of determining the material utilization percentage as recited in claim 5, wherein the mass of the initial blank (Mb) and the mass of the formed part (Mp) are calculated using the following equations [EQ. 2] and [EQ. 3] respectively:
Mb=L*W*ρ*t [EQ.2];
wherein:
L=the length of the initial blank;
W=the width of the initial blank;
ρ=a density of the sheet material; and
t=an initial blank thickness; and
if M₁>M₂, then Mp=M₂; else Mp=M₁ [EQ.3].

7. The method of determining the material utilization percentage as recited in claim 6, wherein the material utilization percentage (MU) is calculated using the following equation [EQ. 4]:
$$MU = \frac{Mp}{Mb} * 100. \qquad [ EQ . 4 ]$$

8. A system for determining a material utilization percentage during a stamping process, the system comprising:
a first user input;
a finite element method (FEM) model database;
a second user input that is different from the first user input;
a third user input that is different from the first user input and the second input;
a materials database;
a graphic user interface (GUI) operable to receive the first user input, the second user input, and the third user input; and
a controller in communication with the FEM model database, and the materials database, wherein the GUI is configured to send the first user input to the FEM model database, the second user input to the controller, and the third user input to the controller, wherein the controller is configured to:
receive the first user input via the GUI;
read a developed blank geometry and/or a formed part geometry, each of which are represented by a plurality of elements, wherein the developed blank geometry and/or the formed part geometry is read from the first user input received, and wherein each of the plurality of elements representing the developed blank geometry and/or the formed part geometry includes a plurality of nodes associated with each of the plurality of elements representing the developed blank geometry and/or the formed part geometry;
determine a nominal blank thickness of the developed blank geometry based on the plurality of elements representing the developed blank geometry read from the FEM model database;
receive the second user input via the GUI;
determine a length and a width of an initial blank, wherein each of the length and the width of the initial blank are determined based upon plurality of the nodes associated with each of the plurality of elements representing the developed blank geometry, and the second user input received;
receive the third user input via the GUI;
compare the third user input with material data stored within the materials database, wherein the material data includes a plurality of material types, and at least one material characteristic associated with each of the plurality of material types;
identify the at least one material characteristic from the third user input received;
calculate a mass of the initial blank and a mass of a formed part, wherein the mass of the initial blank is calculated based upon the nominal blank thickness of the developed blank geometry determined, and the length and the width of the initial blank determined, and wherein the mass of the formed part is calculated based upon the at least one of the material characteristic identified, and an accumulated mass of each of the plurality of elements representing the formed part geometry; and
calculate the material utilization percentage based upon the mass of the initial blank and the mass of the formed part.

9. The system for determining the material utilization percentage as recited in claim 8, wherein determining the nominal blank thickness of the developed blank geometry based on the plurality of elements representing the developed blank geometry includes:
reading, via the controller, the plurality of elements representing the developed blank geometry from the FEM model database; and
looping, via the controller, through the plurality of elements representing the developed blank geometry, wherein looping through the plurality of elements representing the developed blank geometry includes:
reading, via the controller, a part identification, and an element thickness for each of the plurality of elements representing the developed blank geometry from the FEM model database;
determining, via the controller, a maximum thickness of the developed blank geometry based on the element thickness for each of the plurality of elements representing the developed blank geometry;
determining, via the controller, a minimum thickness of the developed blank geometry based on the element thickness for each of the plurality of elements representing the developed blank geometry;
calculating, via the controller, an absolute thickness difference of the developed blank geometry based on the maximum thickness of the developed blank geometry determined and the minimum thickness of the developed blank geometry determined; and
determining, via the controller, the nominal blank thickness of the developed blank geometry based on an average of the maximum thickness of the developed blank geometry determined and the minimum thickness of the developed blank geometry determined, when the absolute thickness difference calculated is greater than a predefined allowable thickness difference.

10. The system for determining the material utilization percentage as recited in claim 9, wherein the controller is further configured to:
identify the nominal blank thickness as uniform, when the absolute thickness difference determined is less than the predefined allowable thickness difference.

11. The system for determining the material utilization percentage as recited in claim 9, wherein determining a length and a width of the initial blank includes:
reading, via the controller, the plurality of nodes associated with each of the plurality of elements representing the developed blank geometry from the FEM model database; and
looping, via the controller, through the plurality of nodes associated with each of the plurality of elements representing the developed blank geometry, wherein looping through the plurality of nodes associated with each of the plurality of elements representing the developed blank geometry includes:
reading, via the controller, an X-coordinate, a Y-coordinate, and a Z-coordinate for each of the plurality of nodes associated with each of the plurality of elements representing the developed blank geometry;
identifying, via the controller, a maximum X value, a minimum X value, a maximum Y value, and a minimum Y value for the initial blank;
determining, via the controller, the length of the initial blank based on the maximum X value identified and the minimum X value identified; and
determining, via the controller, the width of the initial blank based on the maximum Y value identified and the minimum Y value identified.

12. The system for determining the material utilization percentage as recited in claim 11, wherein the accumulated mass (Mᵢ) of each of the plurality of elements is calculated using the following equation [EQ. 1]:
$${M}_{i} = ρ {\sum }_{j = 1}^{N ( i )} {t}_{i}^{j} {A}_{i}^{j} ; \qquad [ EQ . 1 ]$$
wherein:
ρ=a density of the sheet material;
N(i)=a total number of elements in part (i);
j=a number of elements per part (i);
i=a part identification, wherein i is equal to 1 or 2;
$${t}_{i}^{j} = a thickness of a {j}^{th} element of an {i}^{th} part identified ; and$$
$${A}_{i}^{j} = an area of the {j}^{th} element of the {i}^{th} part identified .$$

13. The system for determining the material utilization percentage as recited in claim 12, wherein the mass of the initial blank (Mb) and the mass of the formed part (Mp) are calculated using the following equations [EQ. 2] and [EQ. 3] respectively:
Mb=L*W*ρ*t [EQ.2];
wherein:
L=the length of the initial blank;
W=the width of the initial blank;
ρ=a density of the sheet material; and
t=an initial blank thickness; and
if M₁>M₂, then Mp=M₂; else Mp=M₁ [EQ. 3].

14. The method of determining the material utilization percentage as recited in claim 13, wherein the material utilization percentage (MU) is calculated using the following equation [EQ. 4]:
$$MU = \frac{Mp}{Mb} * 100. \qquad [ EQ . 4 ]$$

15. A system for determining a material utilization percentage during a stamping process, the system comprising:
a first user input including at least one finite element model (FEM) data file;
a finite element method (FEM) model database;
a second user input including a margin between an edge of an initial blank and an edge of a developed blank geometry;
a third user input including a selected material type;
a materials database;
a graphic user interface (GUI) operable to receive the first user input, the second user input, and the third user input; and
a controller in communication with the FEM model database, and the materials database, wherein the GUI is configured to send the first user input to a finite element method (FEM) model database, the second user input to the controller, and the third user input to the controller, wherein the controller is configured to:
receive the at least one FEM data file via the first user input, wherein the at least one FEM data file is received into the FEM model database;
read a developed blank geometry and/or a formed part geometry, each of which is represented by a plurality of elements, wherein the developed blank geometry and/or the formed part geometry is read from the at least one FEM data file received, and wherein each of the plurality of elements representing the developed blank geometry and/or the formed part geometry includes a plurality of nodes associated with each of the plurality of elements representing the developed blank geometry and/or the formed part geometry respectively;
determine a nominal blank thickness of the developed blank geometry based on the plurality of elements representing the developed blank geometry read from the FEM model database;
receive the margin between the edge of an initial blank and the edge of the developed blank geometry via the second input;
determine a length and a width of the initial blank, wherein each of the length and the width of the initial blank are determined based upon plurality of the nodes associated with each of the plurality of elements representing the developed blank geometry, and the margin received;
receive a selected material type via the third user input, wherein the selected material type is received into the materials database;
compare the selected material type with material data stored within the materials database, wherein the material data includes a plurality of material types, and at least one material characteristic associated with each of the plurality of material types;
identify the at least one material characteristic for the selected material type received;
calculate a mass of the initial blank and a mass of a formed part, wherein the mass of the initial blank is calculated based upon the nominal blank thickness of the developed blank geometry determined, and the length and the width of the initial blank determined, and wherein the mass of the formed part is calculated based upon the at least one material characteristic identified, and an accumulated mass of each of the plurality of elements representing the formed part geometry; and
calculate the material utilization percentage based upon the mass of the initial blank and the mass of the formed part.

16. The system for determining the material utilization percentage as recited in claim 15, wherein determining the nominal blank thickness of the developed blank geometry based on the plurality of elements includes:
reading, via the controller, the plurality of elements representing the developed blank geometry from the FEM model database; and
looping, via the controller, through the plurality of elements representing the developed blank geometry, wherein looping through the plurality of elements representing the developed blank geometry includes:
reading, via the controller, a part identification, and an element thickness for each of the plurality of elements representing the developed blank geometry from the FEM model database;
determining, via the controller, a maximum thickness of the developed blank geometry based on the element thickness for each of the plurality of elements representing the developed blank geometry;
determining, via the controller, a minimum thickness of the developed blank geometry based on the element thickness for each of the plurality of elements representing the developed blank geometry;
calculating, via the controller, an absolute thickness difference of the developed blank geometry based on the maximum thickness of the developed blank geometry determined and the minimum thickness of the developed blank geometry determined; and
determining, via the controller, the nominal blank thickness of the developed blank geometry based on an average of the maximum thickness of the developed blank geometry determined and the minimum thickness of the developed blank geometry determined, when the absolute thickness difference calculated is greater than a predefined allowable thickness difference.

17. The system for determining the material utilization percentage as recited in claim 16, wherein determining a length and a width of the initial blank includes:
reading, via the controller, the plurality of nodes associated with each of the plurality of elements representing the developed blank geometry from the FEM model database; and
looping, via the controller, through the plurality of nodes associated with each of the plurality of elements representing the developed blank geometry, wherein looping through the plurality of nodes associated with each of the plurality of elements representing the developed blank geometry includes:
reading, via the controller, an X-coordinate, a Y-coordinate, and a Z-coordinate for each of the plurality of nodes associated with each of the plurality of elements representing the developed blank geometry;
identifying, via the controller, a maximum X value, a minimum X value, a maximum Y value, and a minimum Y value for the initial blank;
determining, via the controller, the length of the initial blank based on the maximum X value identified and the minimum X value identified; and
determining, via the controller, the width of the initial blank based on the maximum Y value identified and the minimum Y value identified.

18. The system for determining the material utilization percentage as recited in claim 17, wherein the accumulated mass (Me) of each of the plurality of elements is calculated using the following equation [EQ. 1]:
$${M}_{i} = ρ {\sum }_{j = 1}^{N ( i )} {t}_{i}^{j} {A}_{i}^{j} ; \qquad [ EQ . 1 ]$$
wherein:
ρ=the density of the sheet material;
N(i)=total number of elements in part (i);
j=a number of elements per part (i);
i=a part identification, wherein i is equal to 1 or 2;
$${t}_{i}^{j} = a thickness of a {j}^{th} element of an {i}^{th} part identified ; and$$
$${A}_{i}^{j} = an area of the {j}^{th} element of the {i}^{th} part identified .$$

19. The system for determining the material utilization percentage as recited in claim 18, wherein the at least one material characteristic is a density of a sheet material used to form the initial blank; and
wherein the mass of the initial blank (Mb) and the mass of the formed part (Mp) are calculated using the following equations [EQ. 2] and [EQ. 3] respectively:
Mb=L*W*ρ*t [EQ.2];
wherein:
L=the length of the initial blank;
W=the width of the initial blank;
ρ=a density of the sheet material; and
t=an initial blank thickness; and
if M₁>M₂, then Mp=M₂; else Mp=M₁ [EQ. 3].

20. The system for determining the material utilization percentage as recited in claim 19, wherein the material utilization percentage (MU) is calculated using the following equation [EQ. 4]:
$$MU = \frac{Mp}{Mb} * 100. \qquad [ EQ . 4 ]$$
